(19) United States
(12) Patent Application Publication
(10) Pub. No.: US 2011/0145027 A1
(43) Pub. Date: Jun. 16, 2011

(54) SYSTEM FOR VISUALLY PROCESSING AND PRESENTING COST ESTIMATES

(76) Inventor: Nicusor Mihai, Portland, OR (US)

(21) Appl. No.: 12/959,294

(22) Filed: Dec. 2, 2010

Related U.S. Application Data
(60) Provisional application No. 61/284,031, filed on Dec. 12, 2009.

(51) Int. Cl. G06Q 10/00

(52) U.S. Cl. 705/7.11

(57) ABSTRACT

A system and method for visually processing and presenting cost estimates includes a CPU; primary input hardware for entering data and commands to the CPU; output hardware including a display for displaying information; a memory unit having a stored 2D/3D puzzle database, a stored assembly information record list database, and a stored item information record list database. Drawing board windows, puzzle takeoff windows, item takeoff windows, and assembly takeoff windows allow an operator to create puzzles by drawing or importing images and associate assemblies or material items with them, and by dragging and dropping (copying and pasting) selected puzzles to a drawing board window create a more complex image comprising all previously selected puzzles and generating a cost estimate containing all the assemblies and items associated with the puzzles dragged and dropped (copied and pasted) to the drawing board, without the need for third-party imaging or estimating software.

The entire disclosure of U.S. Provisional Application No. 61/284,03, filed Dec. 6, 2009, the benefit of which is claimed, is considered to be part of the disclosure of the accompanying application, and is hereby incorporated by reference.

### BACKGROUND OF THE INVENTION

The accurate estimation of a large-scale construction project is a daunting but necessary task in order for the project to be adequately scoped and managed. For electrical utilities in particular there are multiple options for developing high dollar value projects from wind and solar power generation to transmission and distribution of energy, where the process of engineering procurement and the subsequent construction is very time consuming and very expensive.

For any construction project it is highly desirable that the total cost of a project be known as early as possible within the design phase. Often, multiple design options are under consideration, in the early planning stages, when there is minimal information available and the cost of a final product (construction project) is needed to determine which design is more cost effective. Having the possibility of visually creating an estimate based on limited information, such as a one-line diagram could significantly reduce cost and time, sometimes in the millions of dollars for electrical utility companies.

The most inefficient part of construction cost estimating is determining the amount of resources needed for the construction of a project. This is also known as quantity takeoff. Quantity takeoff is a very long and error-prone process that is often performed manually by estimators; Missing and/or duplicating work items can frequently occur during the quantity takeoff process.

Various software computer systems are available to aid in the cost estimation process. Most available estimating packages rely on a digitizing capability. For example, a computer aided design (CAD) file is loaded into the software package and the image is electronically measured (dimensioned) and broken down into its elements (e.g., doors, walls, windows, etc.). The cost of each of the elements is then extracted from various databases and the total cost is calculated. Typically, the databases contain structural material costs, assembly costs (i.e., known components that are grouped together for ease; e.g., an appropriately dimensioned nut would be grouped with a bolt as one assembly), and labor costs. Unfortunately, the estimator is left with little flexibility to create, delete, and modify the existing CAD image and its associated material items and assemblies. The assembly and item lists frequently have tens of thousands of associated assemblies or items listed, making the task of estimating construction projects extremely time consuming. The estimator is simply unable to create his/her own assemblies based on his/her own industry's needs (e.g., electrical utility) and create a visual estimate, allowing the estimator to see the relationship between the construction elements, while simultaneously generating a cost estimate.

### SUMMARY OF THE INVENTION

In accordance with the invention, a computer system and method for visually processing and presenting cost estimates without the need for third-party imaging or estimating software allows the estimator to create, modify, and delete existing items, assemblies, and the images associated with those items/assemblies. When puzzles (which are images created on the drawing board or imported from the computer's memory or World Wide Web and have items/assemblies associated with them) are dragged and dropped (copied and pasted) onto the drawing board, the items/assemblies associated with those puzzles are simultaneously added to the cost estimate. The image of a windmill, for example, could represent $3,000,000 in the estimate, because hundreds of material items from excavation, foundation installation, tower erection, electrical wiring, and construction of the access road to the windmill, to list just a few, are all linked to the one image of the windmill, a tremendous amount of information added to the estimate by dragging and dropping (copied and pasted) a simple puzzle on the drawing board, allowing the design engineer to visually estimate costs during the design process.

### BRIEF DESCRIPTION OF THE DRAWINGS

FIG. 1 is a block diagram illustrating the computer system under an embodiment of the invention;

FIG. 2 is a block diagram representing the puzzle list of a puzzle database, the assembly list of an assembly database, and the item list of an item database stored in the memory of the computer system under an embodiment of the invention;

FIG. 3 is a representation of the main display of the computer system under an embodiment of the invention, displaying the project information module;

FIG. 4 is a representation of the display screen of the computer system under an embodiment of the invention displaying the puzzle-takeoff window, the drawing board window, and the estimating window;

FIG. 5 is a representation of the display screen of the computer system under an embodiment of the invention, displaying the puzzle-creating module/window; here the items or assemblies are associated with the images created on the drawing board or imported from the computer's memory or World Wide Web;

FIG. 6 is a representation of the display screen of the computer system under an embodiment of the invention, displaying the drawing board window;

FIG. 7 is a representation of the display screen of the computer system under an embodiment of the invention, displaying the estimating window;

FIG. 8 is a representation of a portion of the display screen of the computer system under an embodiment of the invention, displaying an enlarged view of the assembly and items importing module/window;

FIG. 9 is a representation of a portion of the display screen of the computer system under an embodiment of the invention, displaying an enlarged view of the craft module/window;

FIG. 10 is a representation of a portion of the display screen of the computer system under an embodiment of the invention, displaying an enlarged view of the variables module/window;

FIG. 11 is a representation of a portion of the display screen of the computer system under an embodiment of the invention, displaying an enlarged view of the layers module/window.

FIG. 12 is a representation of a portion of the display screen of the computer system under an embodiment of the invention, displaying an enlarged view of the page setup module/window and the drawing board module/window;

FIG. 13 is a representation of a portion of the display screen of the computer system under an embodiment of the invention, displaying an enlarged view of the puzzle-database module/window;

FIG. 14 is a representation of the display screen of the computer system under an embodiment of the invention, displaying the assembly and items exporting function and window;

FIG. 15 is a representation of a portion of the display screen of the computer system under an embodiment of the invention, displaying the object tools, text tools, format tools standard tools, align tools group tools, draw tools, and layer tools;

FIG. 16 is a representation of the display screen of the computer system under an embodiment of the invention, displaying image importing module/window; and

FIG. 17 is a block diagram illustrating a method of creating a visual cost estimate according to an embodiment of the invention.

### DETAILED DESCRIPTION

Reference will now be made in detail to embodiments consistent with the present invention, a system and method for visually processing and presenting cost estimates, with specific reference to estimating the costs of a construction project undertaken by an electrical utility. It will be appreciated that the system and method of the present invention may be applied to various plans that require the construction of large-scale physical projects whether it be the construction of a whole neighborhood, electrical system in a town, train tracks and stations network, military base, electrical, mechanical or plumbing systems in a building and the like or small-scale projects like all the electronic circuit boards inside a computer, cell phone and the like that contain hundreds to thousands of components and require multiple design options in a fast track environment before the most cost effective design is send to production.

As used herein, the term “materials” means physical objects; concrete; masonry; metals; wood; plastics; thermal; finishes; mechanical; electrical; and any other construction materials such as structural construction materials. As used herein, the term “puzzle database” means a database composed of 2D or 3D representation of an image associated with the assembly or item that the image represents (e.g. the image of house represents all parts and pieces a particular house is made off, the image of door represents a particular door, etc.). As used herein, the term “assembly database” means a material database which includes multiple material items, or a component list, or file of records composed of fields containing multiple data items (e.g. all parts and pieces a particular house is made off, etc.). As used herein, the term “item database” means a material database which includes material items, or component list, or file of records composed of fields containing data for each particular item part of that database (e.g. item number, item description, item cost, item installation cost, etc.). The puzzle database, assembly database, and the item database, are functionally related in that the items or components listed in the item database may be items or components of assemblies listed in the assembly database as well as standalone items or components not included in an assembly listed in the assembly database, and each particular item and/or assembly has its own image and value.

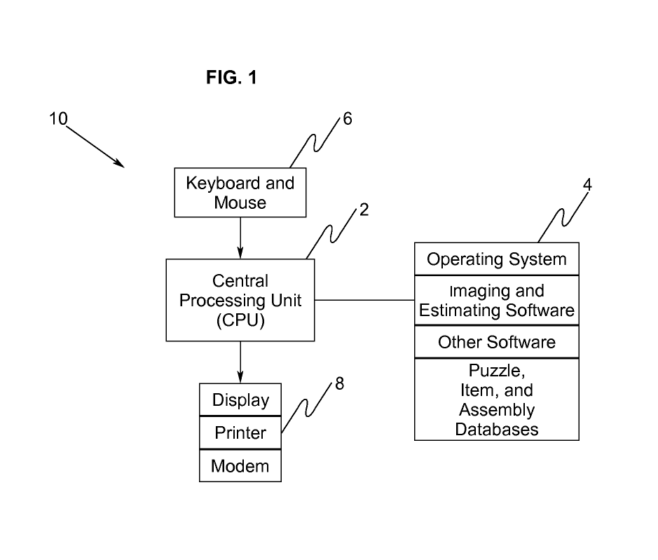

FIG. 1 shows the computer system 10 of the present invention for visually processing and presenting cost estimates. Computer system 10 includes a central processing unit (CPU) 2, memory unit 4, primary input hardware 6, and output hardware 8. All software programs reside within the memory unit 4 of the CPU 2. Primary input hardware 6 typically includes a keyboard and a mouse for efficiently entering data and commands to the CPU 2. Output hardware 8 can include a display such as a monitor screen for displaying drawing boards, puzzle take-off windows, and estimating windows. Additionally, output hardware 8 also could include a printer for providing a hard copy of the estimates, and a modem for transferring data. Both the input hardware 6 and output hardware 8 are functionally connected to CPU 2 either by functional electrical connections or wireless connections. Through the use of computer system 10 an operator or estimator can easily and efficiently make cost estimates at the same time they are designing a new project, or make cost estimates from existing plan prints relating to various projects and various aspects of those projects, such as but not limited to, concrete; masonry; metals; wood; plastics; thermal; finishes; mechanical; electrical; material and labor costs; overall costs, etc.

The computer system 10 and method of the present invention preferably utilize an IBM PC or equivalent hardware (e.g. 16 bit or 32 bit platforms) that operates under WINDOWS, MAC, LINUX or similar software. The computer system preferably includes an Intel PENTIUM 586 processor or compatible computer with a one gigabyte hard drive, 16 megabytes of Random Access Memory (RAM), and a VGA display. The software of the computer system preferably includes the WINDOWS, MAC, LINUX or similar software which is commercially available. The WINDOWS, MAC, LINUX or similar software environment allows multiple software packages to run concurrently and communicate between themselves. Communication between the software packages leverages the software packages functionally into an integrated solution and minimizes software development.

It should also be noted that “module” and “window” are often be used interchangeably in reference to the figures. It should be understood that “window” is the visual display of the portion of a program (module) that carries out a specific function being referenced.

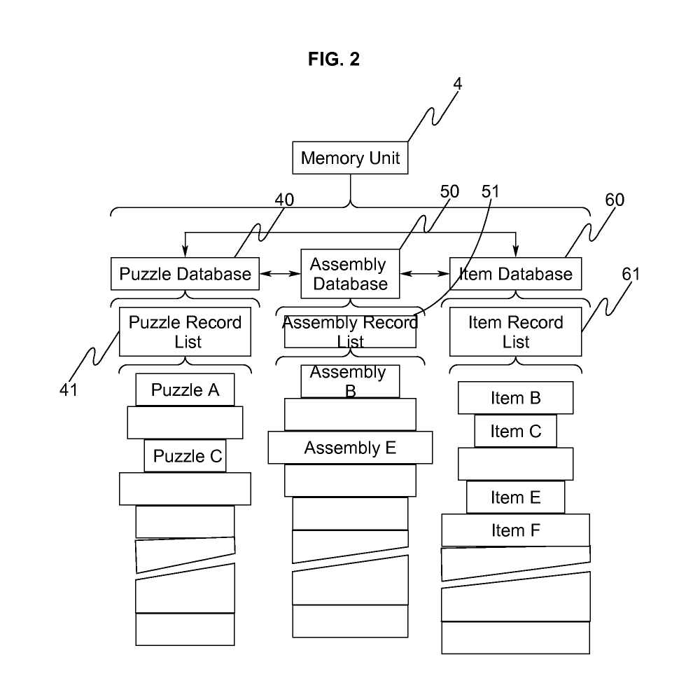

Referring now to FIG. 2, computer system 10, in addition to the operating system, imaging/estimating software, and other software the memory unit 4 of the computer system 10 also includes at least one puzzle database 40, one assembly database 50 related to the puzzle database 40, and at least one item database 60 related to the puzzle database 40 and the assembly database 50. The memory unit 4 may include other puzzle databases, related assembly databases and related item databases not shown in FIG. 2. The puzzle database 40 includes an puzzle information record list 41; the assembly database 50 includes an assembly information record list 51 related to the puzzle information record list 41 of the puzzle database 40, and the item database 60 includes an item information record list 61 related to the puzzle information record list 41 of the puzzle database 40, and related to the assembly information record list 51 of the assembly database 50.

The puzzle record list 41 of the puzzle database 40 contains a listing of potential puzzles that can be used in a particular industry, like the high voltage electrical industry for example, along with additional information relating to the cost (a numerical value) of the assemblies or items associated with those puzzles, and the cost (a numerical value) of installing the assemblies or items associated with those puzzles. Looking at FIG. 2 it can be seen that puzzle record list 41 is comprised of numerous puzzles; “Puzzle A” and “Puzzle C” are noted on FIG. 2. Puzzle A, for example, can be associated with an item only such as, Item B, or it could be associated with an assembly; assemblies are comprised of multiple items. Puzzle A, instead of being associated with

Item B, could be associated with Assembly B, which could be comprised of Item B and Item C. A simple line (puzzle) could represent miles of high voltage transmission line worth millions of dollars installed (assembly). The estimator using computer system 10 has the ability to define what each puzzle represents, tailoring the assemblies, items and images associated with each puzzle to fit his/her industry's needs.

The assembly record list 51 of the assembly database 50 contains a listing of the potential assemblies which can be used on a construction project, e.g. concrete; masonry; metals; wood; plastics; thermal; finishes; mechanical; electrical, etc., along with additional information relating to the cost of the assemblies and the cost (a numerical value) of installing such assemblies. Having these assemblies ready to be associated with a puzzle makes the estimator's or designer's job much easier. When the estimator is adding simple images to the drawing board multiple material items worth potentially millions of dollars will automatically be added to the estimate.

The related item record list 61 of the item database 60 contains listings or breakdowns of the material components utilized in, or alternate components, which can be used in the various assemblies set forth in the assembly record list 51 of the assembly database 50 along with related cost information. The item record list 61 can also include items or components which can be used alone and not as part of an assembly set forth in the assembly record information list. With the information contained in the puzzle database 40, the assembly database 50, and the item database 60, an estimator using the computer system 10 and method of the present invention can estimate the construction costs related to a selected construction project in total or in part. That is, breaking out the estimated costs for particular segments of the construction project, such as wind farms, substations, transmission and distribution line, etc. The method of the present invention also permits the estimator to select and estimate the costs, including installation costs, of various assemblies and items or components for each construction segment as well as alternative assemblies and items or components for a selected construction project. Also, the user has the option to select and sort the estimate's data and use it as a base to create a construction schedule.

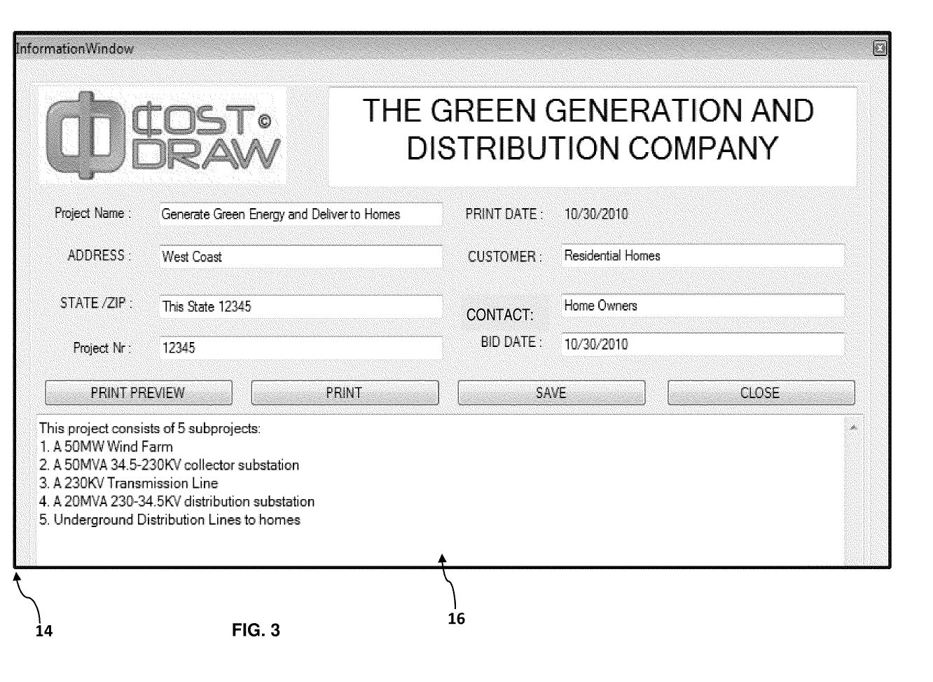

In addition to the aforementioned computer system 10 the present invention also resides in a method of visually creating and presenting a cost estimate. Referring now to FIG. 17, the method 12 of the present invention for creating a visual estimate is illustrated via a block diagram. However, the different modules of computer system 10 allow the user to accomplish method 12 of FIG. 17 are illustrated in FIGS. 3-16.

An estimator/user first logs into the computer system 10. Shown on display screen 14, it is desirable to initially display the project information module/window 16, where users input the project's description and other project specific information, such as the project's name, address, its scope, etc., as show in FIG. 3. The project information module/window 16 allows the estimator/user to define the project.

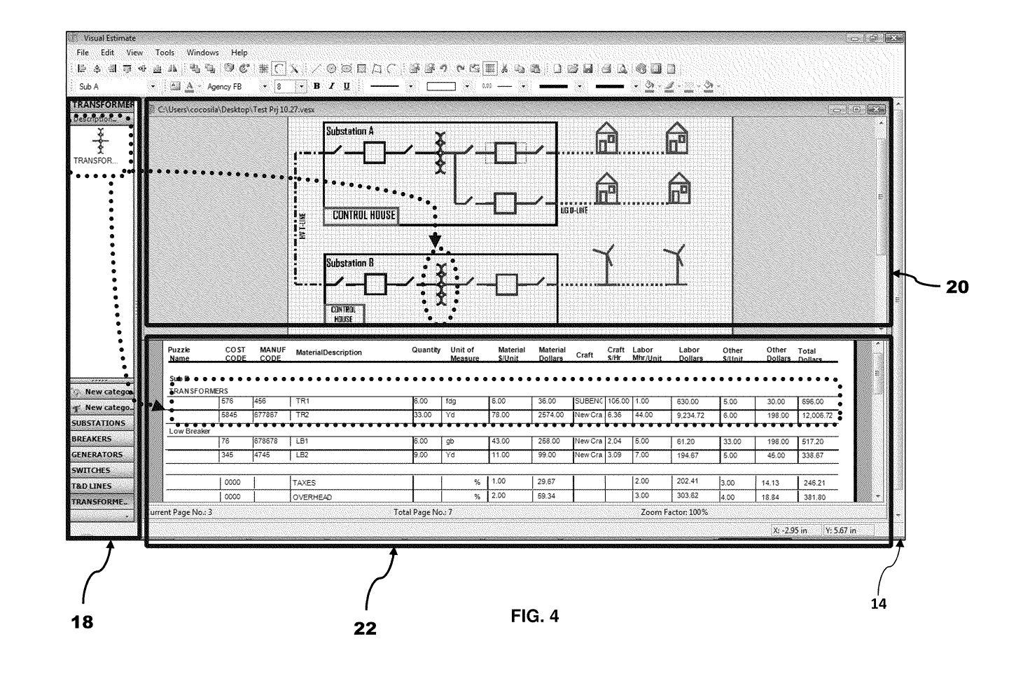

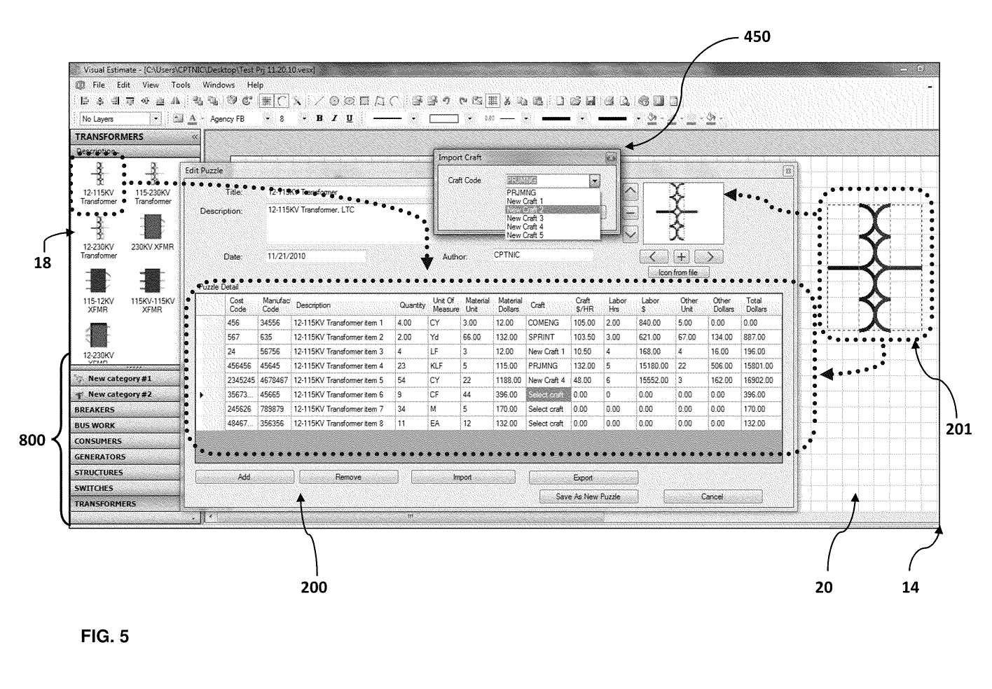

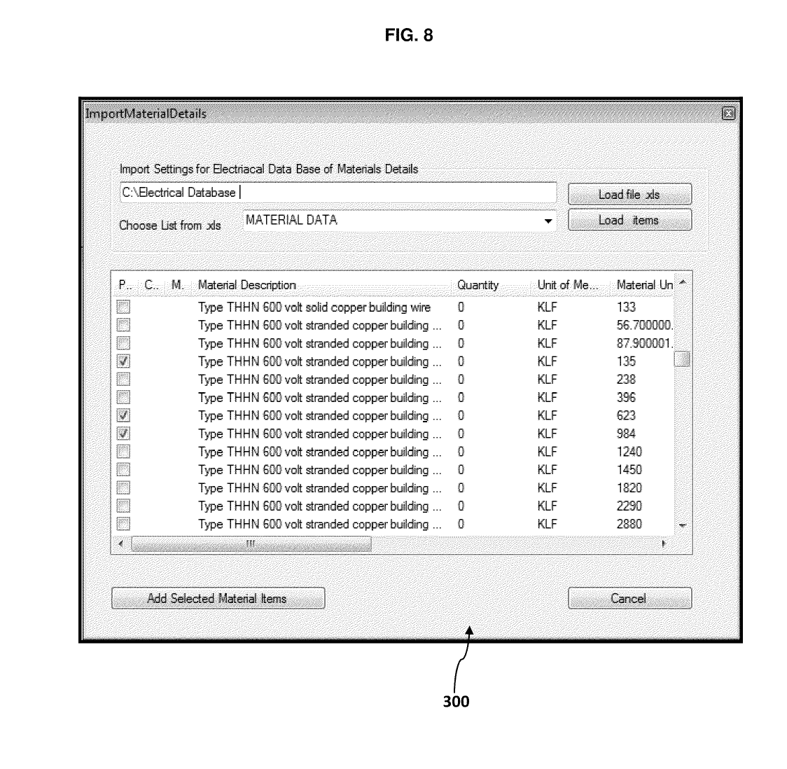

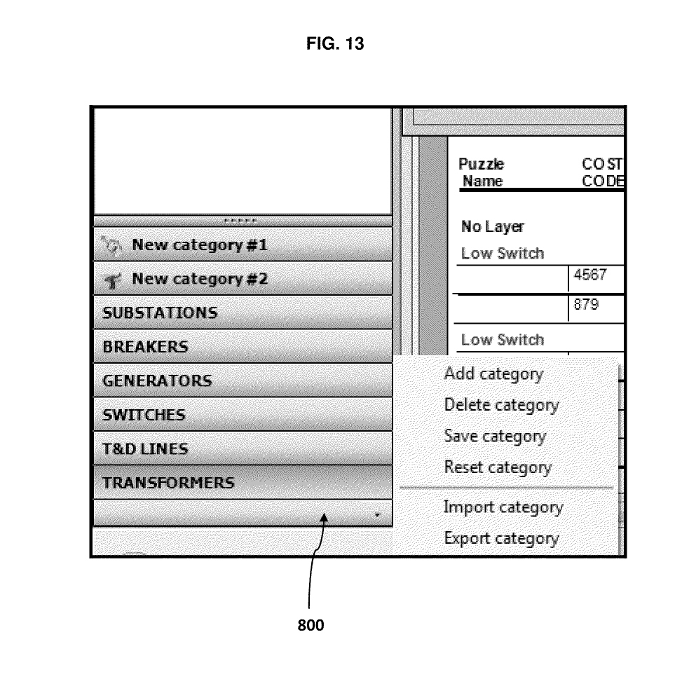

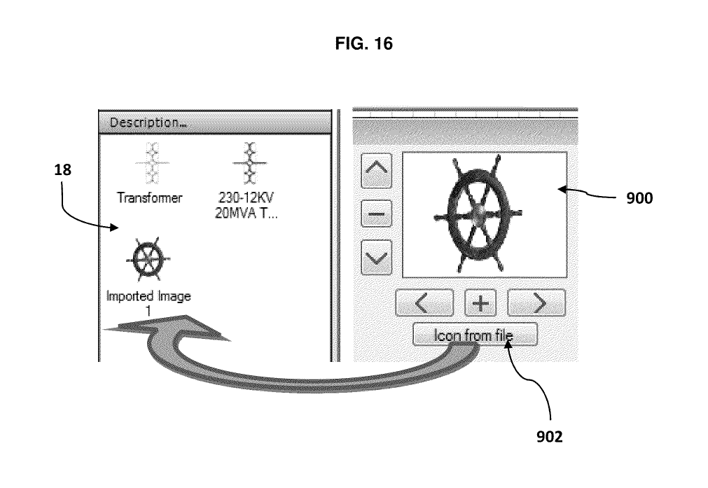

Turning now to FIG. 4 the display screen 14 is visible; however, now the puzzle-takeoff module/window 18, drawing board module/window 20, and estimating module/window 22, are now visible. The estimator has several options for creating new estimates. For example, one option would be to import existing puzzles from existing puzzle database(s) 800 (See FIG. 13) and drag and drop (copy and paste) them on the drawing board window 20. Another option would be to draw new images on the drawing board window 20 and associate them in the puzzle-creating module/window 200 with items or assemblies imported using the assembly and items importing module/window 300 (See FIG. 8) or new items created in the puzzle-creating module/window 200 (See FIGS. 5, 6 and 7). Another option would be importing images from anywhere on the computer or on the World Wide Web using the image-importing module/window 900 (See FIG. 16) and associate them in the puzzle-creating module/window 200 with items or assemblies imported using the assembly and items importing module/window 300 (See FIG. 8) or new items created in the puzzle-creating module/window 200 (See FIGS. 5, 6 and 7). Whichever method is used, the estimator/user of computer system 10 is creating or importing images and associating material items with those images to create puzzles, so when the selected puzzles are dragged or copied the images associated with these puzzles are dropped or pasted onto the drawing board module/window 20 and the material items associated with these puzzle are automatically added in the estimating module/window 22. It should be noted that “dragging and dropping” or “copying and pasting” are well known terms in the art and are synonymous terms meaning to copy an object/image from one position on the computer screen to another position on the computer screen. It will be appreciated that by using the system and method of the present invention when dragging/copying puzzles from an existing database 800 an identical image as included in the puzzle dragged/copied is dropped/pasted on the drawing board window 20 and similar items or assemblies as included in the puzzle dragged/copied are added to the estimating module/window 22, while the original puzzle stays part of the database it was dragged/copied from.

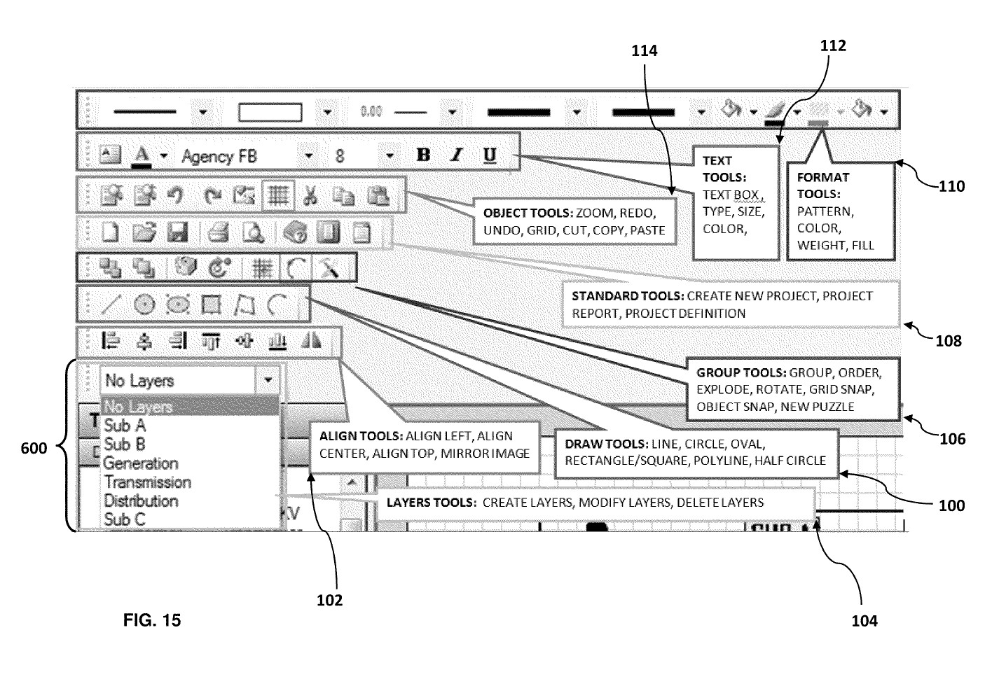

One of the most novel aspects of the present invention is the ability for the estimator/user to create his/her own images, and then associate those images with individual material items or assemblies to create new puzzles. FIG. 5 shows drawing tools 100 (See FIG. 15) users are using to create glyphs (e.g., draw circles, lines, ovals, arcs, etc.) on the drawings board module/window 20 which grouped together form a new image 201, assemblies or material items are imported from the assembly or item database (50, 60) or newly created in the puzzle-creating module/window 200, associated with the newly created image 201 in the puzzle-creating module/window 200, and the newly created puzzle is saved in the project-puzzle database 800 to be used on current or future estimates. FIG. 13 is an enlarged view of the project-puzzle database 800 illustrating that the estimator/user can create and modify (or import and modify) desired puzzles, and save those puzzles in designated categories/folders (electronic folders, which are well know in the art) to be used on current or future estimates. Should the user opt to import an image via the image-importing module/window 900 as illustrated in FIG. 16, he/she simply employs the Icon from File function 902 to import the image. Assemblies or material items can now be imported from the assembly database 50 or item database 60, or created in the puzzle-creating module/window 200, and associated with the newly imported image in the puzzle-creating module/window 200. The puzzle is saved in the project-image database/window 800 in a designated category/folder to be used on current or future estimates. Additionally, as illustrated in FIG. 8 is the import assemblies/items function 300. By selecting desired material items from the databases 50, 60 the items are quickly added to the puzzle creating module/window 200 to facilitate the process of creating new puzzles to be used for new or existing estimates.

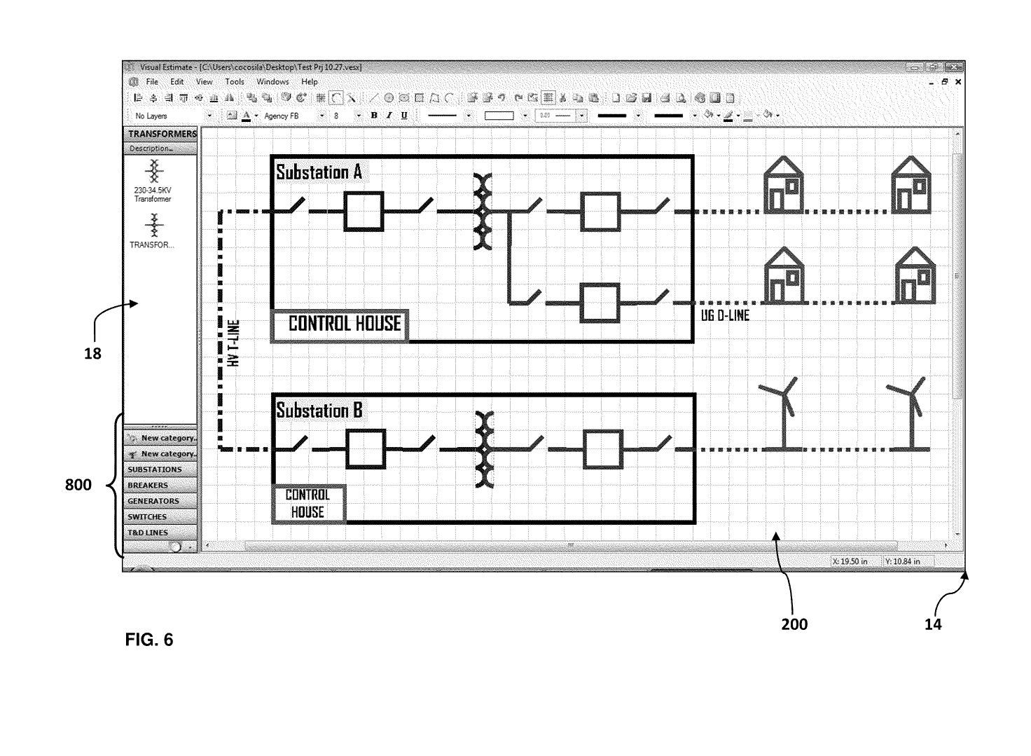

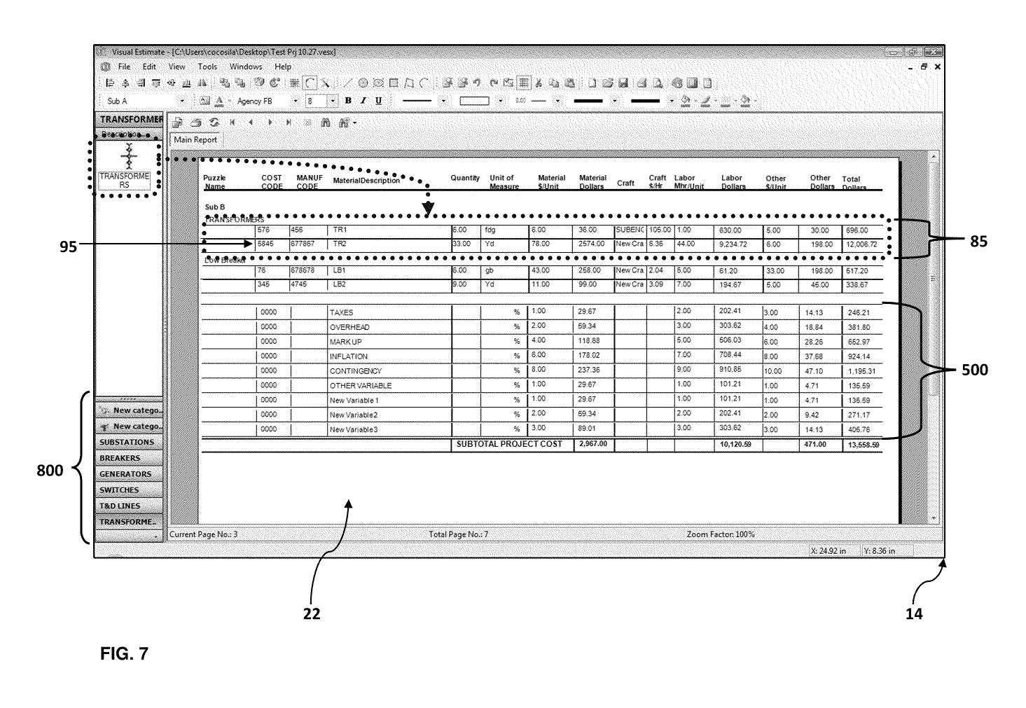

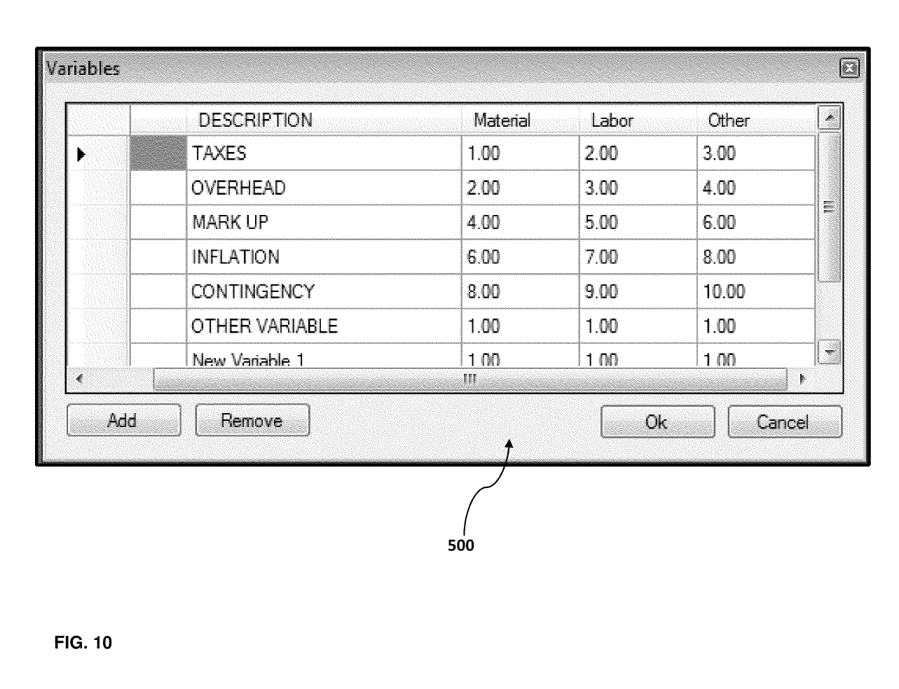

Turning now to FIGS. 5 and 6, the estimator, at any time can select existing or import the project-puzzle database 800 needed to get the desired puzzles related to the project to be estimated. The selected puzzles will show up in the puzzle takeoff module/window 18. The puzzle takeoff module/window 18 relating to the project-puzzle database 800 includes the puzzles which the estimator intends to use in making his estimate whether for an entire construction project or a subproject. The puzzles contained in the puzzle takeoff module/window 18 are typically selected by name, description, type, number, etc., and by dragging/coping selected puzzles from the puzzle takeoff module/window 18 and dropping/pasting them in a logical (predefined) order on the drawing board window 20, the estimator creates a more complex drawing containing all the images associated with all previously dragged and dropped (copied and pasted) puzzles while a cost estimate is simultaneously and automatically generated within estimating module/window 22 containing all the items or assemblies associated with the puzzles dragged and dropped (copied and pasted) on the drawing board window 20. The estimator could go back and forth between the puzzle takeoff module/window 18, the drawing board module/window 20 and the estimate module/window 22, which contains the assemblies 85 and items 95, for example, that resulted from selecting the desired puzzles. This is especially useful when the estimator believes he/she has finished the takeoff based on an existing preliminary design and wants to fine tune the estimate by adjusting the assemblies 85 and item quantities 95, material and labor cost, or other variables, as shown in the variable module/window 500, pertaining to the estimate (See FIGS. 7 and 10). As illustrated in FIG. 10, the variables module/window 500 can include variables such as taxes, overhead, mark-up, inflation, etc. At any time the estimator could make the changes to the predefined quantity, material cost, or unit of labor in order to comply with certain conditions.

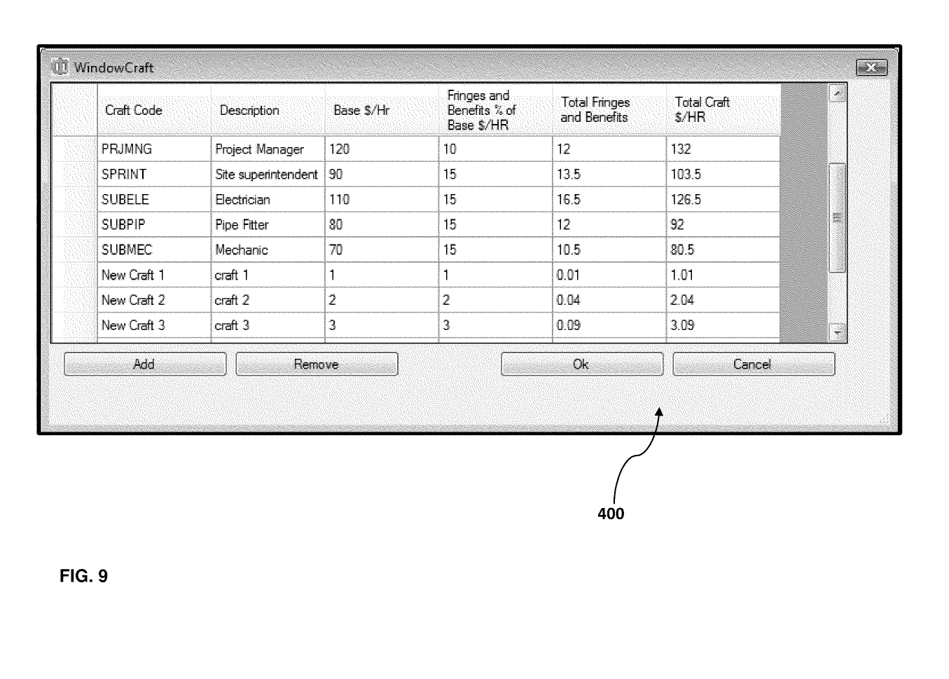

As shown in FIG. 9 the estimator, before or during estimating process has the option to create or import the desired crafts using the craft module/window 400. As illustrated in FIG. 9 it is within the craft module/window 400 that the user creates/selects/modifies the specific type of labor needed on the project (e.g., electricians, pipe fitters, project managers, etc.). By creating desired crafts in this module, when the user is creating new material items and clicks on the “Select Craft” cell inside the puzzle creating module/window 200, the import-craft module/window 450 (See FIG. 5) pops up allowing the user to be quickly select the desired craft for the newly added material item in order to speed up the process of creating new puzzles.

Before or during estimating process the computer operator has the option to create desired project variables using the variable module/window 500 as illustrated in FIG. 10, which are then included in the estimating module/window 22 as part of each project or subproject so the estimates can be modified based on the values selected for each variable.

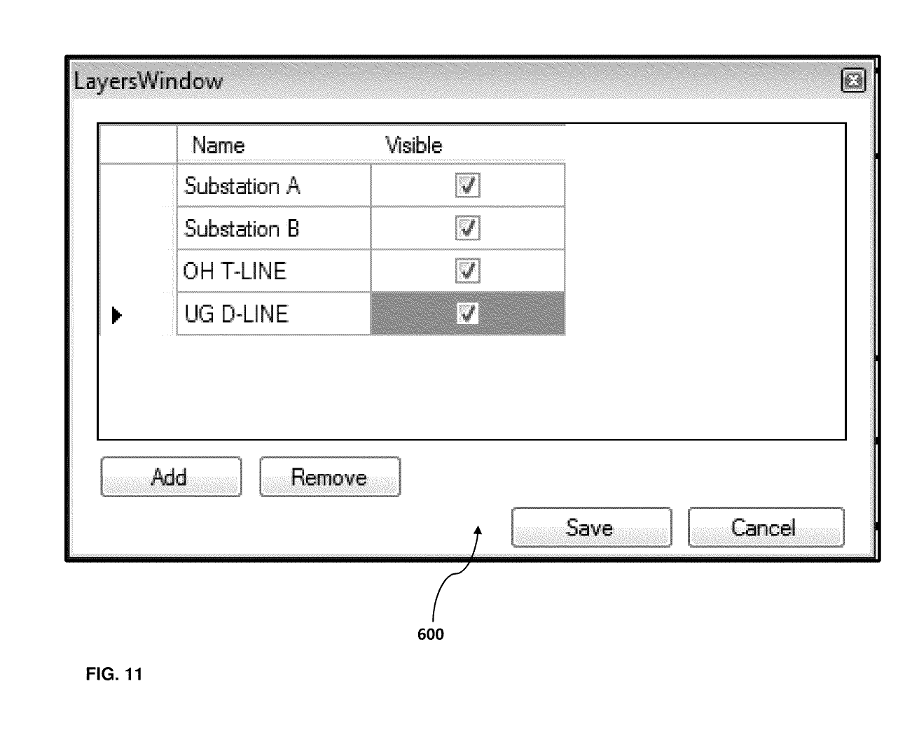

Before or during estimating process the computer operator has the option to create new layers (subprojects) which allows him/her to create subprojects as part of the main project (a subproject for each layer) so when they drag/copy and drop/paste puzzles in these layers the estimating module/window 22 creates a separate estimate for each layer containing the material items associated with each puzzle dragged/copied and dropped/pasted in that layer. See FIG. 11.

Puzzles can be copied onto the drawing board window 20 in a desired layer 600 or no particular layer depending on the estimating needs; however, when the estimate is created by the estimating module 22 there will be a separate estimate created for each layer/subproject, containing the items or assemblies associated with the puzzles dragged and dropped (copied and pasted) in each layer and a separate estimate for other items/assemblies not associated with a particular layer. This way the estimator can break down a big project into smaller manageable subprojects each one with its own estimate, and also have another estimate for tasks that are associated with all subprojects (like overhead for example) in order to have a total project cost (numerical value). Layers can be turned on/off in the layers window 600, however only layers that are turned ON are visible on the drawing board window 20 and included in the estimating window 22.

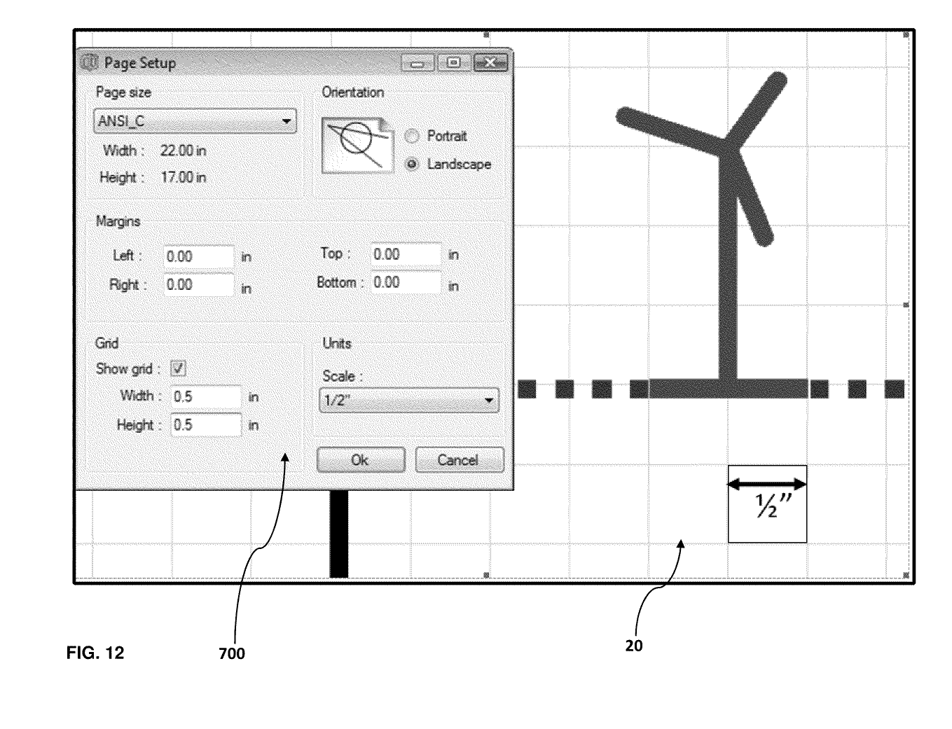

Looking now at FIG. 12, the page setup module/window 700 is illustrated. Before or during estimating process the computer operator has the option to set up the drawing area and it's parameters by using the page setup module/window 700; users select desired page size and grid size to allow them to draw the desired project within a desired layout and print on the desired page size.

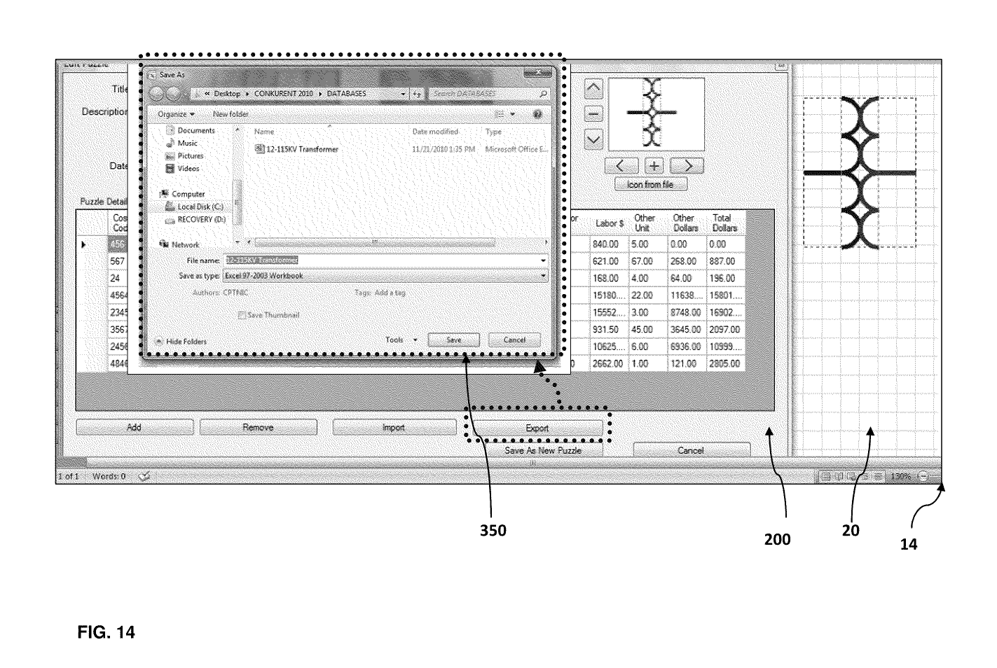

FIG. 14 illustrates the assembly and items exporting function 350. Since some puzzles may have hundreds of material items associated with them. By exporting these material items associated with a particular puzzle, those items are saved in a separate spreadsheet and can then be easily imported to create a new or similar puzzle.

As illustrated in FIG. 15 computer system 15 includes various tools for efficiently completing a variety of tasks. In addition to drawing tools 100, there are numerous other modification tools, which include: align tools 102 (e.g., align left, align right, mirror image, etc.); layer tools 104 (e.g., create layers, modify layers, delete layers, etc.); group tools 106 (e.g. order, explode, rotate, grid snap, etc.); standard tools 108 (e.g., create new project, project report, project definition, etc.,); format tools 110 (e.g., pattern, color, weight, fill, etc.); text tools 112 (e.g. type, size, color, etc.); and object tools 114 (e.g. zoom, redo, undo, cut, copy, etc.).

The complete image (FIG. 6) is the “visual” part or the visual estimate of computer system 10; the image which was created by dragging and dropping (copying and pasting) selected puzzles from takeoff module/window 18 onto the drawing board module/window 20, allowing the estimator to visually build the estimate while designing the construction project. The complete design will be saved along with its related cost estimate, and can be stored in the memory, used as a base for another estimate, printed, or transferred to another computer, etc. through the use of a modem, disks, or other conventional computer communication means.

Finally, referring again to FIG. 17, the method 12 of the present invention for creating a visual estimate is illustrated via a block diagram. The elements of method 12 for creating a visual estimate are preferably embodied in a software program running on computer system 10. It should be appreciated that the elements shown in FIG. 17 are separated into functional characteristics of the software program. Method 12 of the present invention commences when the estimator logs onto the computer system 10 and opens the project-information window (step 1002). The user must then decide to create/define a new or existing estimate (step 1004); define the new/existing estimate (step 1006), by either selecting the estimate parameters of an existing estimate (step 1008) or define/import/select the variable, crafts, layers, etc, for a new/existing estimate (step 1024).

Once an estimate has already been defined upon logging into computer system 10 (step 1004), or has been newly defined via step 1024, the estimator is ready to select the first puzzle (step 1026) from the puzzle takeoff module/window 18 and drag and drop (copy and paste) it on the drawing board window 20 (step 1028). Once at least one puzzle is on the drawing board window 20, the user can choose to move to step 1010, or choose to continue building the visual estimate by selecting a second puzzle (step 1030) from the puzzle takeoff module/window 18 and dragging and dropping/copying and pasting the puzzle on the drawing board window 20 (step 1032).

Some puzzles will connect in a predefined (logical) way (step 1034) depending on the desired design; however, puzzles do not have to be connected to each other. If the user(s) want to create a new puzzle, then using the drawing tools 100 and other tools 102, 104, 106, 108, 110, 112 and 114 (illustrated in FIG. 15), they can draw the desired image on the drawing board window 20, associate material items with it using the puzzle-creating module/window 200, and save it in the database 800 in the desired folder to be used on the current or future projects.

If the users want to modify an existing puzzle from the database 800, they will drag and drop (copy and paste) the puzzle on the drawing board window 20 and using the drawing tools 100 and other tools 102, 104, 106, 108, 110, 112 and 114 they can modify the puzzle to the desired form, associate material items with it using the puzzle-creating module/window 200, and save it in the database 800 in the desired folder to be used on the current or future projects.

The process of selecting or creating/modifying new puzzles for addition to the drawing board 20 is iterative (steps 1036, 1038, 1040, 1042, 1044, 1046) until the final puzzle is selected (step 1048) and dropped on the drawing board 20 (step 1050).

Once the parameters are defined for an existing estimate (steps 1008 or 1024), when the user drags and drops (copies and pastes) puzzles on the drawing board 20 (step 1028, 1032, 1040, 1044 and 1050) the items or assemblies associated with the puzzles dragged and dropped (copied and pasted) on the drawing board window 20 are added to the estimate in the estimating window 22 (step 1010). The user can now revise the estimate by adjusting quantity, labor, unit price, etc. (step 1012); add, delete, or modify items or assemblies (step 1014); select or change variables (step 1016); turn layers on/off (step 1018); save, print, export estimate to spreadsheet or email (step 1020); and finally review a detailed report and completed visual image of the estimate (step 1022).

It is to be understood that the invention is not limited in its application to the details of construction and to the arrangements of the components set forth in the preceding description or illustrated in the drawings. The invention is capable of other embodiments and of being practiced and carried out in various ways. Also, it is to be understood that the phraseology and terminology employed herein are for the purpose of descriptions and should not be regarded as limiting.

The above description will enable any person skilled in the art to make and use the invention. It also sets forth the best odes for carrying out this invention. There are numerous variations and modifications thereof that will also remain readily apparent to others skilled in the art, now that the general principles of the present invention have been disclosed. As such, those skilled in the art will appreciate that the conception upon which this disclosure is based may readily be utilized as a basis for the designing of other structures, methods, and systems for carrying out the purposes of the present invention. It is important, therefore, that the claims be regarded as including such equivalent constructions insofar as they do not depart from the spirit and scope of the present invention.

What is claimed is:

1. A computer-implemented system for visually processing and presenting project cost estimates comprising:
a central processing unit;
primary input hardware; and
primary output hardware; wherein said central processing unit, said input hardware, and said output hardware are functionally connected;
wherein said central processing unit further comprises a memory unit, said memory unit containing an operating system, a puzzle database, an assembly database, and a material item database; wherein said memory unit further comprises;
a project information module;
a puzzle creating module;
a puzzle-takeoff module;
a drawing board module; and
an estimating module;
wherein said operating system allows said puzzle database, said assembly database, said item database, said puzzle creating module, project information module, said puzzle-takeoff module, said drawing board module; and said estimating module to run concurrently and communicate between themselves.

2. The computer-implemented system for visually processing and presenting project cost estimates of claim 1 wherein said puzzle database includes an puzzle information record list;
wherein said assembly database includes an assembly information record list; and
wherein said item database includes an item information record list wherein said assembly information record list is functionally related to said puzzle information record list, said item information record list is functionally related to said puzzle information record list and functionally related to said assembly information record list.

3. The computer-implemented system for visually processing and presenting project cost estimates of claim 2 wherein said puzzle record list comprises numerous puzzles associated with images, assemblies, and items related to a specific industry;
said assembly record list comprises numerous assemblies related to a specific industry; and
said item record list comprised numerous items related to a specific industry.

4. The computer-implemented system for visually processing and presenting project cost estimates of claim 3 wherein a user defines how said puzzle is functionally related to said images, and said assemblies and said items related to a specific industry.

5. The computer-implemented system for visually processing and presenting project cost estimates of claim 4 wherein said user defines how said assembly is functionally related to said items.

6. The computer-implemented system for visually processing and presenting project cost estimates of claim 5 wherein said input hardware comprises, a mouse and a keyboard for entering data and commands into said central processing unit and said output hardware comprises a monitor, a printer, and a modem.

7. The computer-implemented system for visually processing and presenting project cost estimates of claim 6 further comprising;
an assembly and items importing module;
a puzzle importing module;
a craft module;
a variables module;
a layers module;
a page-setup module; and
a puzzle-database module; wherein
said operating system allows said assembly and items importing module, said puzzle importing module, said craft module, said variable module; said layers module, said page-setup module;
and said puzzle-database module to run concurrently and communicate between themselves.

8. The computer-implemented system for visually processing and presenting project cost estimates of claim 7 wherein said estimating module automatically provides a numerical cost estimate of said project based on said puzzles dragged and dropped (copied and pasted) on said drawing board module.

9. The computer-implemented system for visually processing and presenting project cost estimates of claim 8 wherein said drawing-board module automatically creates a visual estimate of said project based on said puzzles dragged and dropped (copied and pasted) said drawing board module.

10. A computerized method of visually processing and presenting project cost estimates, including the steps of:
i. creating a first puzzle by associating a first image with a first material item from a specific industry or a first assembly from a specific industry;
ii. dragging and dropping (copying and pasting) said first puzzle onto the drawing board window in a first layer/subproject;
iii. creating a second puzzle by associating a second image with a second material item from a specific industry or a second assembly from a specific industry;
iv. dragging and dropping (copying and pasting) said second puzzle onto said drawing board window in a second layer/subproject;
v. modifying said first puzzle by associating said first image with a third material item or third assembly from a specific industry;
vi. dragging and dropping (copying and pasting) said first puzzle onto said drawing board window in said first layer/subproject or said second layer/subproject;
vii. modifying said second puzzle by associating said second image with a fourth material item or a fourth assembly from a specific industry.
viii. dragging and dropping (copying and pasting) said second puzzle onto said drawing board window in said first layer/subproject or said second layer/subproject;
ix. automatically generating a numerical cost estimate for said first layer/subproject and said second layer/subproject based on the values associated with said first puzzle and said second puzzle dragged and dropped (copied and pasted) in said first layer/subproject and said second layer/subproject.

11. The computerized method of visually processing and presenting project cost estimates of claim 10 further including one or more iterations of said steps i.

12. The computerized method of visually processing and presenting project cost estimates of claim 10 further including one or more iterations of said step iii.

13. The computerized method of visually processing and presenting project cost estimates of claim 10 further including one or more iterations of said step v.

14. The computerized method of visually processing and presenting project cost estimates of claim 10 further including one or more iterations of said step vii.

15. The computerized method of visually processing and presenting project cost estimates of claim 10 further including one or more iterations of said step ix.

16. The computerized method of visually processing and presenting project cost estimates of claim 10 further including one or more iterations of said step xi.

17. The computerized method of visually processing and presenting project cost estimates of claim 10 further including linking said images on said drawing board in a logical way as to visually connect said images, building a visual estimate.

18. The computerized method of visually processing and presenting project cost estimates of claim 17 further including employing modification tools for revisions to said visual estimate and said numerical cost estimate

19. The computerized method of visually processing and presenting project cost estimates of claim 18 wherein said modification tools include draw tools.

20. A computerized method of visually processing and presenting project cost estimates, including the steps of:
i. electronically extracting assembly cost information and material item cost information being stored in one or more databases;
ii. associating said assembly cost information or said material item cost information with an image creating a puzzle;
iii. allowing the user to modify said puzzle, said image, said assembly information, and said material item information based on industry specific requirements;
iv. dragging and dropping (copying and pasting) said puzzle to a drawing board window; and
v. automatically creating a numerical cost estimate based on the value associated with said puzzle.
